(19) United States
(12) Patent Application Publication
(10) Pub. No.: US 2004/0035936 A1
(43) Pub. Date: Feb. 26, 2004

(54) Barcode and its reading device

(76) Inventors: Keiji Hoson, Nagano (JP); Eiji Imai, Nagano (JP); Hiroshi Nakamura, Nagano (JP)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/462,485

(22) Filed: Jun. 16, 2003

(30) Foreign Application Priority Data
Jun. 17, 2002 (JP) 2002-176198

(51) Int. Cl. G06K 7/10; G06K 19/06

(52) U.S. Cl. 235/462.16

(57) ABSTRACT

A barcode comprises a combination of multiple line elements of different line widths, wherein a specific barcode comprises a combination of different heights in the line elements, together with the combination of different line widths. Such bar code is difficult to make a copy of. The related reading device is also described.

### CROSS REFERENCE TO RELATED APPLICATION

This application claims priority of Japanese Application No. 2002-176198, filed on Jun. 17, 2002, the complete disclosure of which is hereby incorporated by reference.

### BACKGROUND OF THE INVENTION

a) Field of the Invention

The present invention relates to a barcode which is composed of a combination of multiple line elements of different line widths, and a device for reading the barcode. More specifically described, the present invention relates to a barcode which is difficult to make a copy of, and its reading device.

b) Description of the Related Art

Generally a barcode is used to attach various administrative information about products, etc. to objects. A barcode is composed of a combination of multiple line elements of different line widths. Generally, a label on which this type of barcode is printed is attached to a product. A projection-and-depression pattern (a rugged pattern) can be molded to create a barcode (see Japanese Laid-open Patent Application H9-69131). Normally, a barcode is read by an optical method of reflection. In many cases, a barcode is attached to stocks, bonds, and gift certificates.

### Problems Addressed by the Invention

With the above-described barcode, however, the different line elements of the barcode are printed as they are. Therefore, it is easy to duplicate the code or read the contents. Thus, the barcode can be relatively easily reproduced by a duplicate technique such as copying and printing and can be attached to legal stocks and bonds for forgery.

Also, a conventional barcode reading device needs an optical system to read the barcode by an optical method. For this reason, the device needs to be large and results in high costs.

### OBJECT AND SUMMARY OF THE INVENTION

A primary object of the present invention is to provide a barcode which is difficult to be reproduced and read, and its reading device.

To achieve the above object, the invention is a barcode composed of a combination of multiple line elements of different line widths, wherein a specific barcode is composed of a combination of different heights, together with the combination of different line widths.

Since a combination of line elements of different widths and different heights is used to compose a barcode, a flat copying method cannot reproduce the original barcode, and it is also difficult to read it. Thus, a forgery of the barcode is prevented and a forgery of stocks and bonds, which is normally done by attaching the barcode to the stock and bond, can be prevented.

The present invention further provides that the barcode is composed of multiple different combinations and a specific barcode is defined by a combination of line widths at each height. Thus, it is difficult to forge or read the barcode.

The present invention in another form is a barcode composed of a combination of multiple line elements of different line widths, wherein a combination of two different heights is also used to compose the barcode, and a specific barcode is defined by the line widths having the higher height.

Therefore, when the barcode is copied, the line widths with the lower height are also copied. Thus, the true information defined by the line widths with the higher height cannot be reproduced. As a result, a forgery of the barcode can be prevented.

A barcode reading device in yet another form comprises of a line-height detecting portion which moves relative to a medium having a barcode composed of a combination of line elements to detect different heights of the line elements, and a data processing portion which extracts the line heights from the output data obtained by the line-height detecting portion and identifies the line widths corresponding to the line heights in the output data to specify the barcode.

Since the different heights of the line elements are first detected and then the line widths corresponding to the line heights are detected, a barcode composed of a combination of different heights can be read.

In the barcode reading device immediately described above, the invention further comprises of a sensor having the line-height detecting portion and a moving portion for moving the sensor or the medium at a constant speed. Therefore, the barcode can be read while the sensor is being moved.

The present invention further comprises that in the barcode reading device above, a capacitance-detecting sensor or a thermal sensor is used for the sensor. In the barcode reading device above, the invention still further comprises of a thermal sensor for providing the output of the line heights as the image data, a temperature-detecting portion for detecting the temperature of the medium or the sensor, and a heating portion for heating the medium or the sensor. Since an optical sensor is not used, there is no need to provide an optical system, thus making the device small.

### BRIEF DESCRIPTION OF THE DRAWING

In the drawings:

FIG. 1 is a diagram of a barcode of the present invention: FIG. 1(A) is a plan view of the entire barcode; FIG. 1(B) is a cross-sectional view of a duplicated false barcode; FIG. 1(C) is a cross-sectional view of FIG. 1(A) at the L-L line;

FIG. 2 is a plan view showing the relationship between a sensor and the barcode;

FIG. 3 is a block diagram of a barcode reading device of the present invention;

FIG. 4 is a graph of the electrical signals obtained when the barcode is read;

FIG. 5 is a plan view showing the relationship between a sensor of another embodiment and the barcode;

FIG. 6 is a block diagram of a barcode reading device of another embodiment;

FIG. 7 is a diagram showing a scan image of the barcode of another embodiment; and

FIG. 8 is a graph showing the electrical signals obtained when the barcode of another embodiment is read;

### DESCRIPTION OF THE PREFERRED EMBODIMENTS

The configuration of the present invention is described in detail hereinafter based on the best form shown in the figures. FIG. 1 illustrates an embodiment of a barcode of the present invention. Barcode 1 is composed of a combination of multiple line elements of different line widths. As shown in FIG. 1(C), a combination of multiple line elements of different heights is also used to compose a specific barcode 1, together with the combination of multiple line elements of different widths. Since a combination of the line elements of different heights specifies a barcode 1, even when the barcode shown in FIG. 1(C) is copied two-dimensionally, it appears as in FIG. 1(B). Thus, the combination of line elements of different heights cannot be reproduced. In this manner, the original barcode 1 cannot be reproduced, and it is also difficult to read the barcode 1. Consequently, a forgery of the barcode 1 is prevented, and also the forgery of stocks and bonds, which is done by attaching the (duplicated) barcode 1 to the stocks and bonds, can be prevented. The barcode 1 is composed of multiple combinations of different line widths and heights and a combination of line widths having different heights is used to define a specific barcode 1.

In the barcode 1 which is composed of a combination of line elements of different line widths (hereinafter called as bars), a combination of two different heights is also used to compose the barcode 1, as shown in FIG. 1(C) and the line widths with the higher height 2 are used to define a specific barcode 1. When the barcode 1 is copied, the line widths with the lower height 3 are also copied, and therefore, the true information, which is specified by the line widths with the higher height 2, cannot be reproduced. Consequently, a forgery of the barcode 1 can be prevented.

A normal code defined by a standard as shown in FIG. 1(A) (8-digit JAN code: “12345670”) is applied to the barcode 1 externally. FIG. 1(C) shows a cross-sectional view of FIG. 1(A) by the L line, in which each bar printed by a intaglio printing has a predetermined three-dimensional height, h (for example, 20 μm) or a height, ½h. It is desired that fiducial lines 4 be printed by a transparent ink to sandwich the barcode when the barcode 1 is printed. The fiducial lines 4 have the three-dimensional height higher than the height, h, of the bars.

The barcode 1 shown in FIG. 1(C) appears as one shown FIG. 1(B) if copied two-dimensionally. However, since the barcode 1 is specified by the line widths with the higher height 2, the information specified by the bars shown in FIG. 1(C) is different from that shown in FIG. 1(B). For example, the information “12047673” shown in FIG. 1(C) is composed of the line widths having the higher height 2; if this information is copied two-dimensionally, the line widths having the lower height 3 also appear (in the copy) and the information is read as “12345670”. In other words, the two-dimensional copy cannot reproduce the original. Therefore, a forgery of the barcode 1 is prevented, and a forgery of stocks and bonds, which is done by attaching the (duplicated) barcode 1 to the stocks and bonds, can be prevented.

A barcode reading device 5 for reading the above-described barcode 1 is now described.

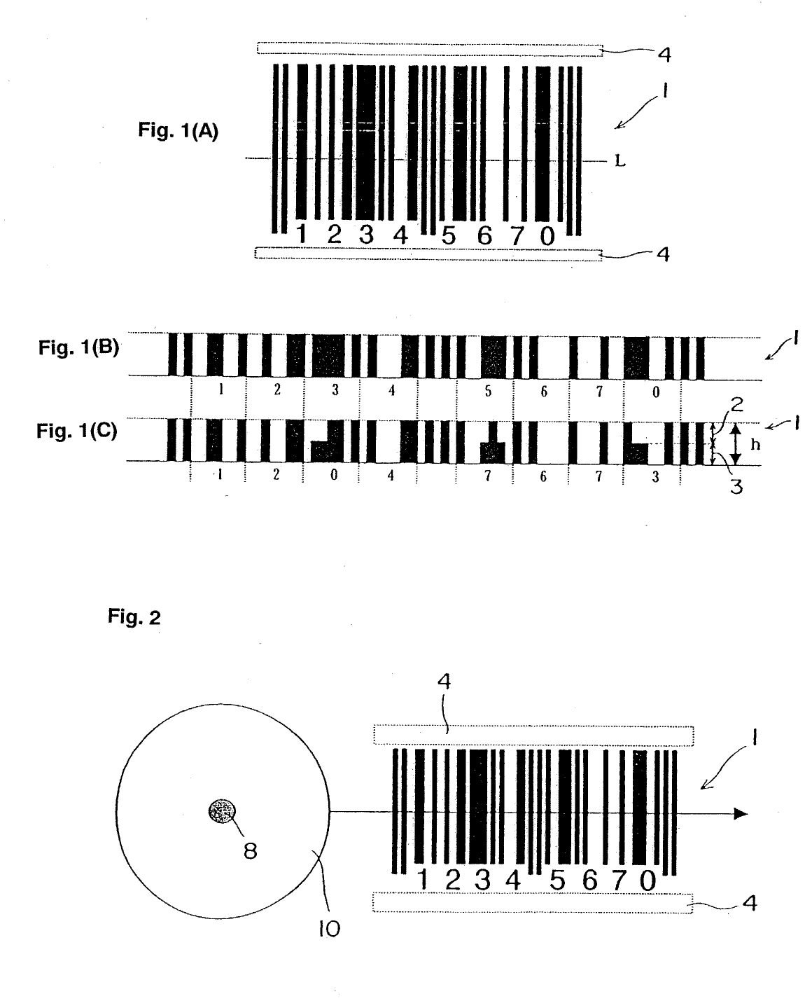

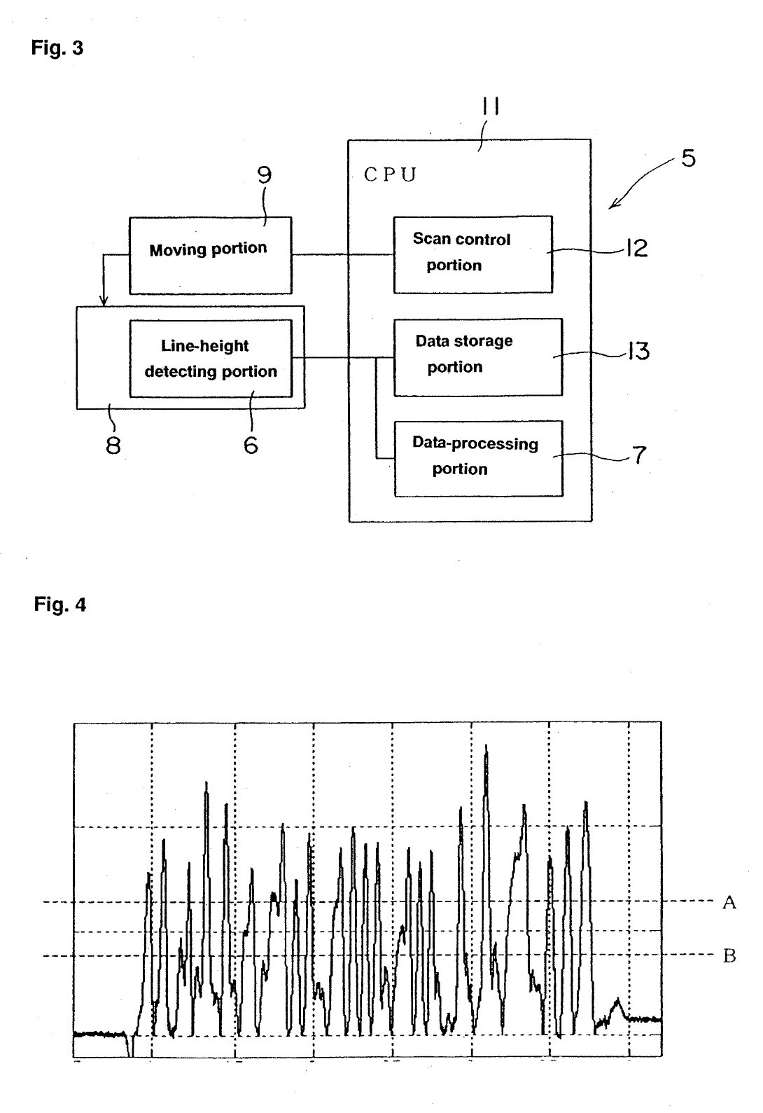

As shown in FIGS. 2 and 3, a barcode reading device 5 comprises of a line-height detecting portion 6, which moves relative to a medium having the barcode 1 composed of a combination of line elements to detect the different heights of the lines, and a data processing portion 7, which extracts the line heights from the output data obtained by the line-height detecting portion 6 and identifies the line widths corresponding to the line heights in the output data to specify the barcode 1. Since the different heights of the line elements are first detected and then the line widths corresponding to the line heights are identified, the barcode 1 which is composed of a combination of bars having the different heights can be read.

Further, the barcode reading device 5 also comprises of a sensor 8, which has the line-height detecting portion 6, and a moving portion 9, which moves the sensor 8 or a medium at a constant speed. Therefore, while the sensor 8 is being moved, the barcode 1 can be read.

A capacitance-detecting sensor, specifically a micro displacement sensor is used for the sensor 8. Since an optical sensor is not used, there is no need of providing an optical system, thus making it possible to make device 5 small. The sensor 8 is held by a cubic sensor-holding body 10. The width of the sensor-holding body 10 is far longer than the length of the barcode 1.

The sensor 8 and the moving portion 9 are controlled by CPU 11. The CPU 11 has a scan-control portion 12, a data-storing portion 13, and a data-processing portion 7. The scan-control portion 12 controls the moving portion 9 to move the sensor 8. The data-storing portion 13 stores the reading data. The data processing portion 7 processes the stored data to decode the barcode 1.

The operation of reading the barcode 1 by the above-described barcode reading device 5 is described hereinafter.

The moving portion 9 moves the sensor-holding portion 10 parallel to the printing surface along the width direction of the barcode 1 at a constant speed such that the sensor 8 is controlled by the scan-control portion 12 to pass over all the bars. At that time, the sensor 8 detects the rugged surface condition of the barcode 1 and then outputs the electrical signals which correspond to the distances from the barcode 1. The signals are digitized one after another and stored in the data-storing portion 13.

More specifically, an example of the data output from the sensor 8 is as shown in FIG. 4. The peaks of the wave line include the data of the three-dimensional heights of the barcode 1. When the data is analyzed in the data-processing portion 7, the three-dimensional heights of the bars are examined to decode the barcode 1. The decoding method is performed in such a way that the interval pattern is compared with the code patterns which are prepared in advance. The interval pattern is composed of coordinates of intersection points of the curve portions, which include the peaks higher than the standard line A, with the straight line B, which is drawn in the center of the waveform. The standard line A is determined by the provided height, h or ½h. Then, the code that has the highest similarity with the interval pattern is output as the reading result. Based on this output, the line widths of the barcode 1 having the higher height, as shown in FIG. 1(C), are read to obtain the information.

The duplicated two-dimensional barcode 1 cannot be read by the barcode reading device 5 as a true barcode 1 would be read. Therefore, it is easily determined if the barcode 1 is a forgery. When stocks, bonds, paper moneys and coins have such a barcode 1 attached, they can be determined to be false.

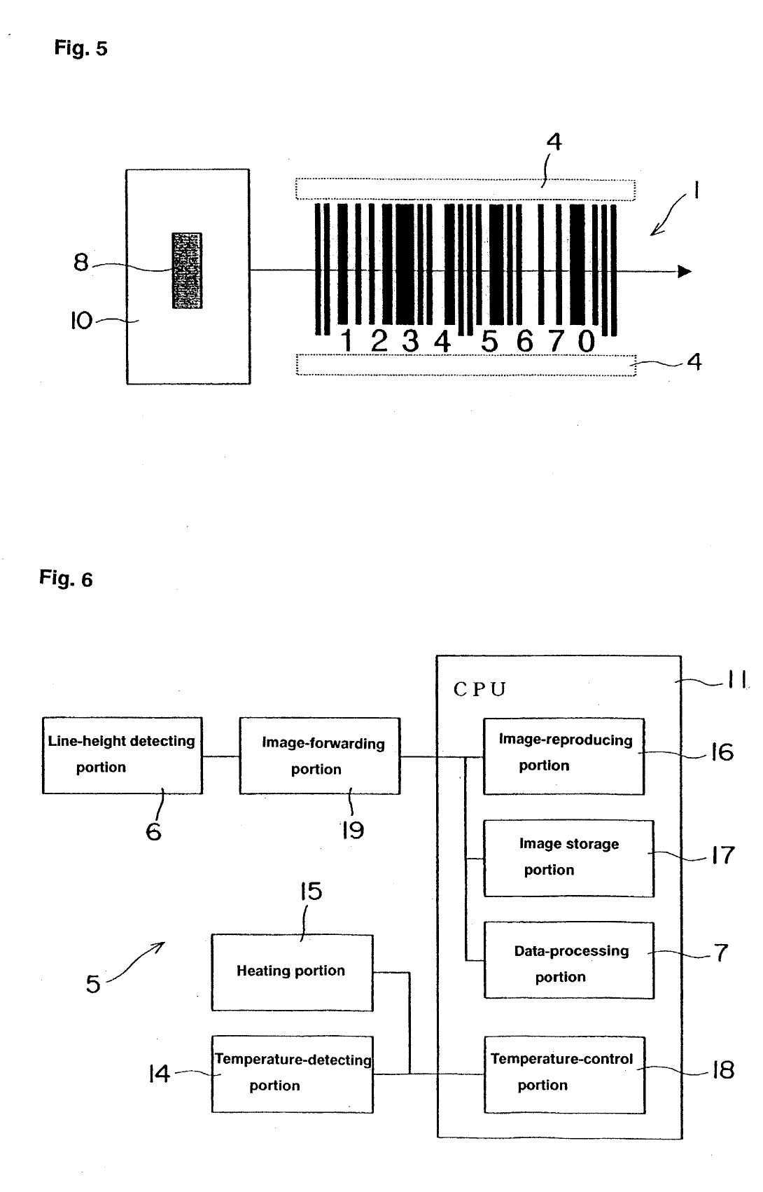

Although the above-described embodiment is an example of the preferred forms of the present invention, the invention is not limited to this. The embodiment can be varyingly modified within the scope of the invention. For example, although a capacitance-detecting sensor is used for the sensor 8 in this embodiment, a thermal sensor may also be used for the sensor 8. In this case, as shown in FIGS. 5 and 6, the barcode reading device 1 is equipped with a temperature-detecting portion 14 for detecting the temperature of a medium or the sensor 8 and a heating portion 15 for heating the medium or the sensor 8. Even in this case, since the sensor 8 is not an optical sensor, there is no need to provide an optical system. Thus, the device can be made small.

The thermal sensor 8 described in Japanese Laid-open Patent Application H10-91769 is used and it gives the output line heights as the image data. In other words, the thermal sensor 8 detects the differences in air temperature, which are caused by the differences in heights of the bars, and creates an image (of the heights). As the thermal sensor 8 is moved over the barcode 1 for scanning, it can output the image data of the barcode 1 according to the heights. With the thermal sensor 8, the ambient in which a measurement object is placed needs to be maintained at a predetermined temperature so that the sensor 8 property can be obtained. For this reason, the heating portion 15 and the temperature-detecting portion 14 need to be provided.

The sensor 8, the heating portion 15, and the temperature-detecting portion 14 are controlled by CPU 11. The CPU 11 has an image-reproducing portion 16, an image storage portion 17, a data-processing portion 7, and a temperature-adjusting portion 18 for controlling the heating portion 15 to adjust the temperature. The sliced images which are scanned by the line-height detecting portion 6 and have passed through an image forwarding portion 19 are stored one after another in the image storage portion 17.

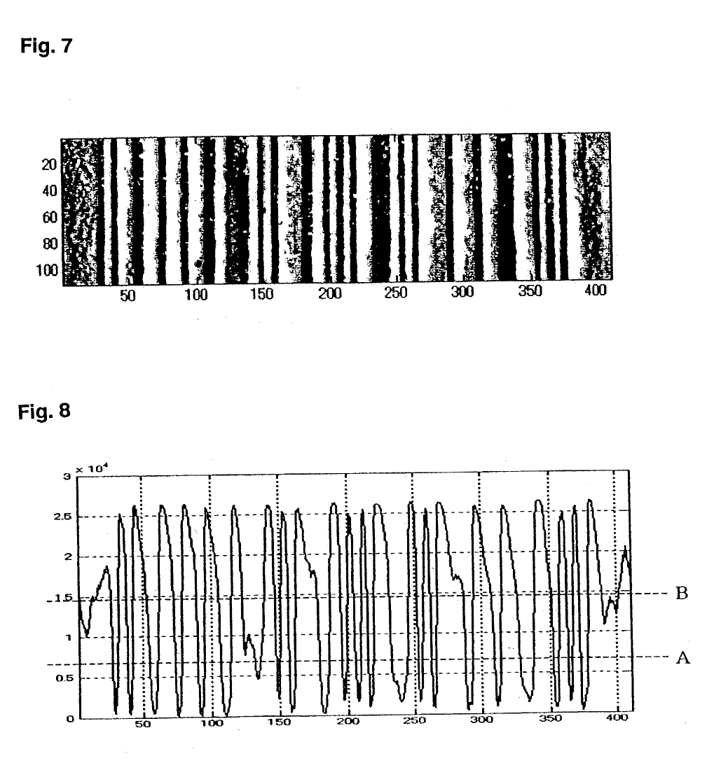

The sliced images stored in the image storage portion 17 are synthesized in the image-reproducing portion 16 by the method described in Japanese Laid-open Patent Application H10-91769 to reproduce the entire image as shown in FIG. 7. The data-processing portion 7 computes the image data which is reproduced.

An example of the computation by the data-processing portion 7 is described hereinafter. The curve shown in FIG. 8 is obtained by projecting each position on the X-axis in FIG. 7 in the Y-axis direction. The peaks in the curve projecting toward the origin of the Y-axis correspond to the bars (the black portions in FIG. 7) and have the values according to their three-dimensional heights. When this data is analyzed, the three-dimensional heights, of the bars are examined to decode the barcode 1. The decoding method is performed in such a way that the interval pattern is compared with the code patterns which are prepared in advance. The interval pattern is composed of coordinates of the intersection points of the curve portions, which include the peaks lower than the standard line A, with the straight line B, which is drawn in the center of the waveform. The standard line A is determined by the provided height, h or ½h. Then, the code that has the highest similarity with the interval pattern is output as a reading result.

Although the barcode 1 has two steps in height as shown in FIG. 1(C) in each of the above-described embodiments, a barcode having three or more steps in height may be used instead.

Also, the barcode 1 is protruded from the print surface in each of the above-described embodiments. However, the print surface may be indented to form a barcode. Even in this case, the height difference can be created using the bar portions and the other portions, and the high-low differences can be also created among the bars.

Although the barcode 1 has a plurality of bars in each of the above-described embodiments, only a single bar may be used and the line element having different heights may be used to produce a barcode.

As described above, the barcode of this invention is composed of a combination of line elements of different heights. Therefore, when the barcode is duplicated two-dimensionally, the original barcode cannot be reproduced. It is also difficult to read the barcode. Consequently a forgery of the barcode can be prevented, and a forgery of stocks and bonds or gift certificates, which is normally done by attaching the duplicated barcode to them, can be prevented.

Since the barcode of the present invention has no difference in appearance from a normal two-dimensional barcode, the fraud barely realizes that it is a three-dimensional barcode. Therefore, a forgery becomes imperfect. Thus, a forgery is more easily prevented.

According to another aspect of the barcode of this invention, a forgery of the barcode and the reading of the barcode become more difficult.

According to yet another aspect of the barcode of this invention, when the barcode is copied, the line widths having the lower height are also copied. Thus, the true information specified by the line widths having the higher height cannot be reproduced. Consequently a forgery of the barcode can be prevented.

According to a further feature of the barcode reading device of this invention, the different heights of the line elements are detected and then the line widths corresponding to the line heights are identified. In this manner, a barcode composed of a combination of different line heights can be read.

Since the three-dimensional micro heights of the barcode are detected (and output) as the two-dimensional image, the property of the barcode can be accurately sampled by the image processing technique. This contributes to an improvement in reliability of the barcode reading device. Further, the device mechanism can be simplified, and a complicated adjustment for the device can be eliminated, thus making the device small and reducing the cost.

According to the barcode reading device of this invention, the barcode can be read while the sensor is being moved.

According to another aspect of the barcode reading device of this invention, an optical sensor is not used, and therefore there is no need of providing an optical system. Thus, the barcode reading device can be made small and simplified, contributing to reducing the cost.

While the foregoing description and drawings represent the present invention, it will be obvious to those skilled in the art that various changes may be made therein without departing from the true spirit and scope of the present invention.

What is claimed is:

1. A barcode comprising a combination of multiple line elements of different line widths, wherein a specific barcode comprises a combination of different heights in said line elements, together with said combination of different line widths.

2. The barcode as set forth in claim 1, wherein a barcode comprises multiple combinations of different widths and heights, and a specific barcode is defined by a combination of line widths at each height.

3. A barcode comprising a combination of multiple line elements of different line widths, wherein a combination of two different heights is also used to compose the barcode, and a specific barcode is defined by the line widths with the higher height.

4. A barcode reading device comprising:
a line-height detecting portion which moves relative to a medium having a barcode composed of a combination of line elements to detect different heights of said line elements; and
a data processing portion which extracts said line heights from the output data obtained by said line-height detecting portion and identifies the line widths corresponding to said line heights in said output data to specify a barcode.

5. The barcode reading device as set forth in claim 4 further comprising:
a sensor having said line-height detecting portion; and
a moving portion for moving said sensor or said medium at a constant speed.

6. The barcode reading device as set forth in claim 4, wherein a capacitance-detecting sensor or a thermal sensor is used for said sensor.

7. The barcode reading device as set forth in claim 4, comprising:
a thermal sensor used for providing the output of said line heights as the image data;
a temperature-detecting portion for detecting the temperature of said medium or said sensor; and
a heating portion for heating said medium or said sensor.
